(19) United States
(12) Patent Application Publication
(10) Pub. No.: US 2010/0329398 A1
(43) Pub. Date: Dec. 30, 2010

(54) Receiver and method for performing interference cancellation

(76) Inventors: Anil M. Rao, Wheaton, IL (US); Henry Ye, Hong Kong (CN); Robert A. Soni, Randolph, NJ (US)

Correspondence Address: Alcatel-Lucent;Docket Administrator, Room 2F-192, 600-700 Mountain Ave., Murray Hill, NJ, 07974-0636, US

(21) Appl. No.: 12/459,351

(22) Filed: Jun. 30, 2009

(51) Int. Cl. H04B 1/10

(52) U.S. Cl. 375/346

(57) ABSTRACT

To address the need for new interference cancellation techniques that are able to deliver adequate performance but with reduced processing requirements, various embodiments are described. In some embodiments, a receiving device demodulates and decodes (101) at least one first-group user from a multi-user input signal. This multi-user input signal includes at least one first-group user and at least one second-group user, the first-group users having a shorter transmission time interval (TTI) than the second-group users. The receiving device reconstructs (102) an interference signal for each of the first-group users that were successfully decoded and subtracts (103) each interference signal from the multi-user input signal to generate an interference-canceled signal. The receiving device then demodulates and decodes (104) at least one second-group user using this interference-canceled signal.

### FIELD OF THE INVENTION

The present invention relates generally to communications and, in particular, to performing interference cancellation in wireless communication systems.

### BACKGROUND OF THE INVENTION

The High Speed Uplink Packet Access (HSUPA) component of the 3GPP UMTS technology adds support for high bit rate, low latency packet data traffic. HSUPA is also referred to as the Enhanced Dedicated CHannel (E-DCH); these terms are used interchangeably. HSUPA was designed so that HSUPA users are able to share the same carrier (i.e., the same spectrum) as the legacy circuit switched (CS) voice users, which is very convenient for cellular operators. Because UMTS and the HSUPA extension utilize asynchronous code division multiple access (CDMA), the signal from one particular user acts as interference to all other users in the same cell; so in particular this means that the addition of HSUPA users acts as interference to CS voice users. Hence, HSUPA includes the addition of an intelligent scheduler in the base station that is able to dynamically schedule the data rates of HSUPA users; in general, the higher the data rate scheduled for the HSUPA users, the higher the uplink interference level that is generated for other users in the cell, including the legacy CS voice users.

There is typically a constraint placed on the total uplink received power level to ensure system stability and also any coverage constraints. The base station scheduler must take care to ensure that the desired capacity of CS voice is achieved while, at the same time, attempting to achieve the highest sector capacity possible given constraints on the total uplink received power level. This is typically done by allocating a certain portion of the total uplink received power level for CS voice (to achieve the desired capacity) and then allocating any remaining allowable total uplink received power to HSUPA users.

The total uplink received power level consists of thermal noise, other cell interference, received power from the in-cell legacy users utilizing the Dedicated Physical Data CHannel (DPDCH) (such as CS voice users), and the in-cell received power from the E-DCH users. The received power level is often also referred to as the received interference level, to signify the fact that the power received from all other users acts as interference to a particular user. The base station scheduler is able to control the level of interference from the E-DCH in-cell users, by adjusting the data rate scheduled to them; the lower the data rate the lower the uplink interference level generated by these users.

Various forms of Interference Cancellation (IC) techniques have been proposed to improve uplink throughput for HSUPA, the idea being that once a particular HSUPA user decodes successfully, the received signal from this user can be reconstructed and subtracted out from the front-end buffer, which reduces the effective interference level seen by the remaining users, thereby improving system performance. This IC process becomes iterative, because if another user is then able to decode successfully following the interference subtraction, this user's received signals subtraction, this user's received signals can be reconstructed and subtracted out from the front-end buffer as well, further reducing the interference level seen by any remaining users. This iterative IC process is illustrated by diagram 900 in FIG. 9.

Performance of this iterative technique can be quite good. Even in a system that has HSUPA-only users, the conventional IC technique will show a performance improvement, as the interference generated by one HSUPA user who decodes successfully can be removed from all of the other HSUPA users that have not yet successfully decoded. However, significant processing power is required to perform multiple stages of decoding, reconstructing, and subtracting HSUPA user interference, all in real-time. Thus, new IC techniques that are able to deliver adequate performance but with reduced processing requirements are nonetheless desirable.

### BRIEF DESCRIPTION OF THE DRAWINGS

FIG. 1 is a logic flow diagram of interference cancellation functionality performed by a device in accordance with various embodiments of the present invention.

FIG. 2 is a block diagram depiction of a device for performing interference cancellation in accordance with various embodiments of the present invention.

FIG. 3 is a timing diagram depiction of interference cancellation performed in accordance with various IC-Lite embodiments of the present invention.

FIG. 4 is a block diagram depiction of the increased throughput possible with various IC-Lite embodiments of the present invention.

FIG. 5 depicts a table containing system level simulation assumptions for a deployment scenario of an IC-Lite embodiment of the present invention.

FIG. 6 depicts a table containing HSUPA-specific simulation assumptions for a deployment scenario of an IC-Lite embodiment of the present invention.

FIG. 7 depicts a table showing the performance gains offered by an IC-Lite embodiment in an interference limited deployment scenario, as a function of the number of CS voice users in the cell.

FIG. 8 depicts a table showing the performance gains offered by an IC-Lite embodiment in a coverage limited deployment scenario.

FIG. 9 is a block diagram depiction of an iterative interference cancellation process as performed in accordance with the prior art.

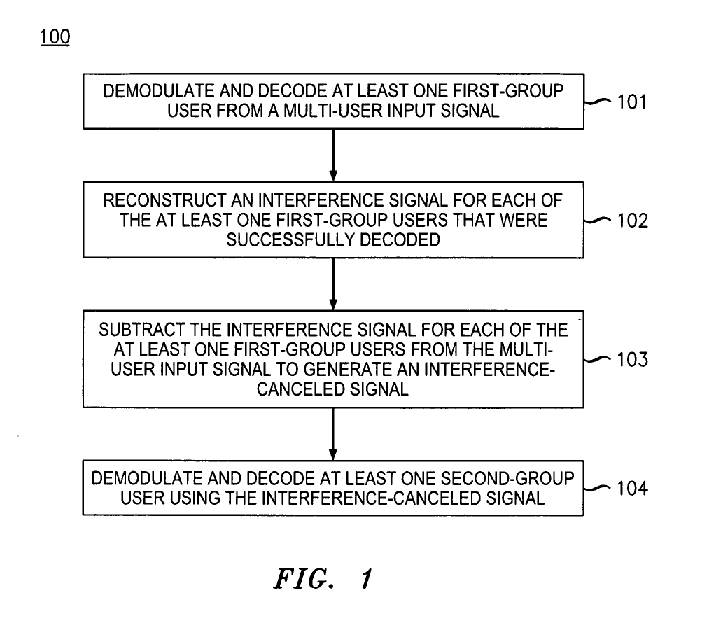

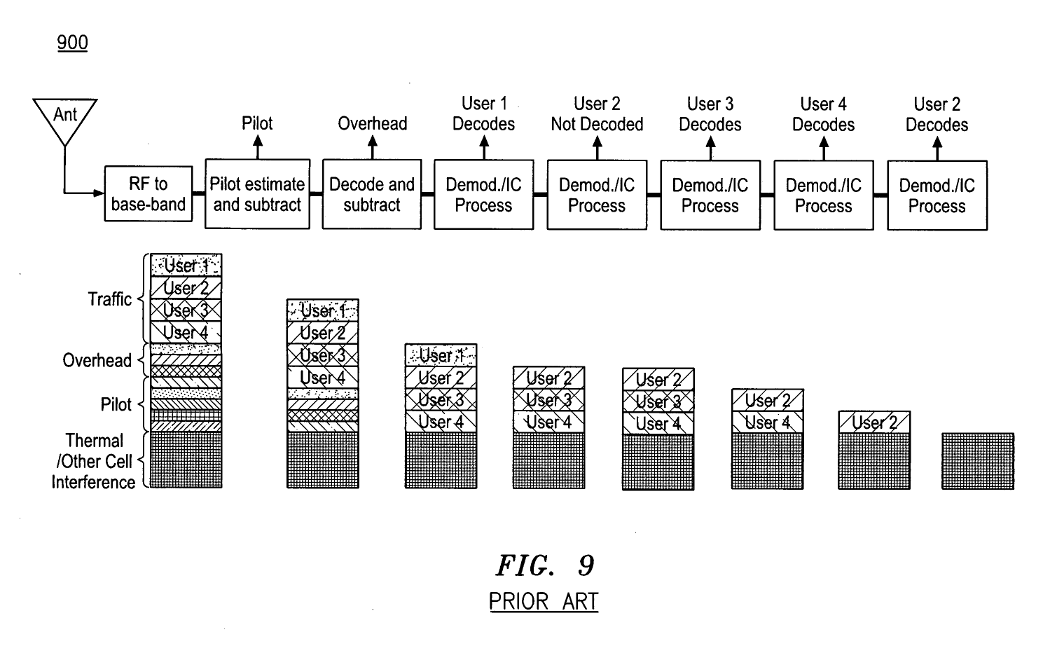

Specific embodiments of the present invention are disclosed below with reference to FIGS. 1-8. Both the description and the illustrations have been drafted with the intent to enhance understanding. For example, the dimensions of some of the figure elements may be exaggerated relative to other elements, and well-known elements that are beneficial or even necessary to a commercially successful implementation may not be depicted so that a less obstructed and a more clear presentation of embodiments may be achieved. In addition, although the although the logic flow diagrams above are described and shown with reference to specific steps performed in a specific order, some of these steps may be omitted or some of these steps may be combined, sub-divided, or reordered without departing from the scope of the claims. Thus, unless specifically indicated, the order and grouping of steps is not a limitation of other embodiments that may lie within the scope of the claims.

Simplicity and clarity in both illustration and description are sought to effectively enable a person of skill in the art to make, use, and best practice the present invention in view of what is already known in the art. One of skill in the art will appreciate that various modifications and changes may be made to the specific embodiments described below without departing from the spirit and scope of the present invention. Thus, the specification and drawings are to be regarded as illustrative and exemplary rather than restrictive or all-encompassing, and all such modifications to the specific embodiments described below are intended to be included within the scope of the present invention.

### SUMMARY OF THE INVENTION

To address the need for new interference cancellation techniques that are able to deliver adequate performance but with reduced processing requirements, various embodiments are described. In some embodiments, a receiving device demodulates and decodes at least one first-group user from a multi-user input signal. This multi-user input signal includes at least one first-group user and at least one second-group user, the first-group users having a shorter transmission time interval (TTI) than the second-group users. The receiving device reconstructs an reconstructs an interference signal for each of the first-group users that were successfully decoded and subtracts each interference signal from the multi-user input signal to generate an interference-canceled signal. The receiving device then demodulates and decodes at least one second-group user using this interference-canceled signal.

Receiving device embodiments are also described. In some embodiments, a receiving device includes a first demodulator/decoder, a signal re-constructor, an interference subtractor, and a second demodulator/decoder. The first demodulator/decoder is for demodulating and decoding at least one first-group user from a multi-user input signal. This multi-user input signal includes at least one first-group user and at least one second-group user, the first-group users having a shorter transmission time interval (TTI) than the second-group users. Coupled to the first demodulator/decoder, the signal re-constructor is for reconstructing an interference signal for each of the first-group users that were successfully decoded. Coupled to the signal re-constructor, the interference subtractor is for subtracting each of the interference signals from the multi-user input signal to generate an interference-canceled signal. Coupled to the interference subtractor, the second demodulator/decoder is for demodulating and decoding at least one second-group user using the interference-canceled signal.

### DETAILED DESCRIPTION OF EMBODIMENTS

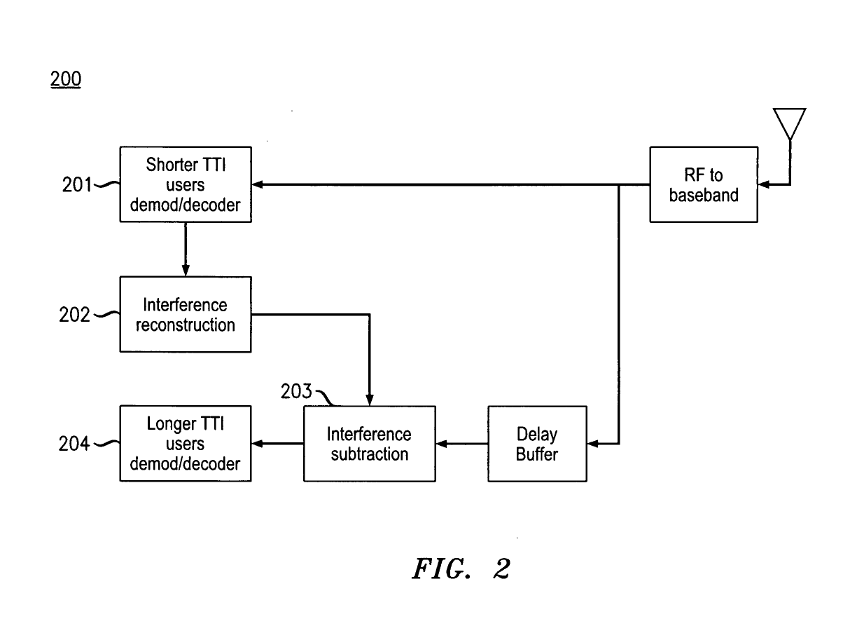

The present invention can be understood with reference to FIGS. 1-2. FIG. 1 depicts interference cancellation functionality performed by a device in accordance with accordance with various embodiments of the present invention. In the method depicted in diagram 100, a receiving device demodulates and decodes (101) at least one first-group user from a multi-user input signal. This multi-user input signal includes at least one first-group user and at least one second-group user, the first-group users having a shorter transmission time interval (TTI) than the second-group users. In some embodiments, the receiving device attempts to demodulate and decode all first-group users encoded in the multi-user input signal. In addition, in some embodiments, multiple (if not all) first-group users are demodulated and decoded concurrently from the multi-user input signal.

The receiving device reconstructs (102) an interference signal for each of the first-group users that were successfully decoded and subtracts (103) each interference signal from the multi-user input signal to generate an interference-canceled signal. Depending on the embodiment, the reconstructing of an interference signal for each of the first-group users that were successfully decoded involves re-encoding and re-modulating an interference signal for each of these users.

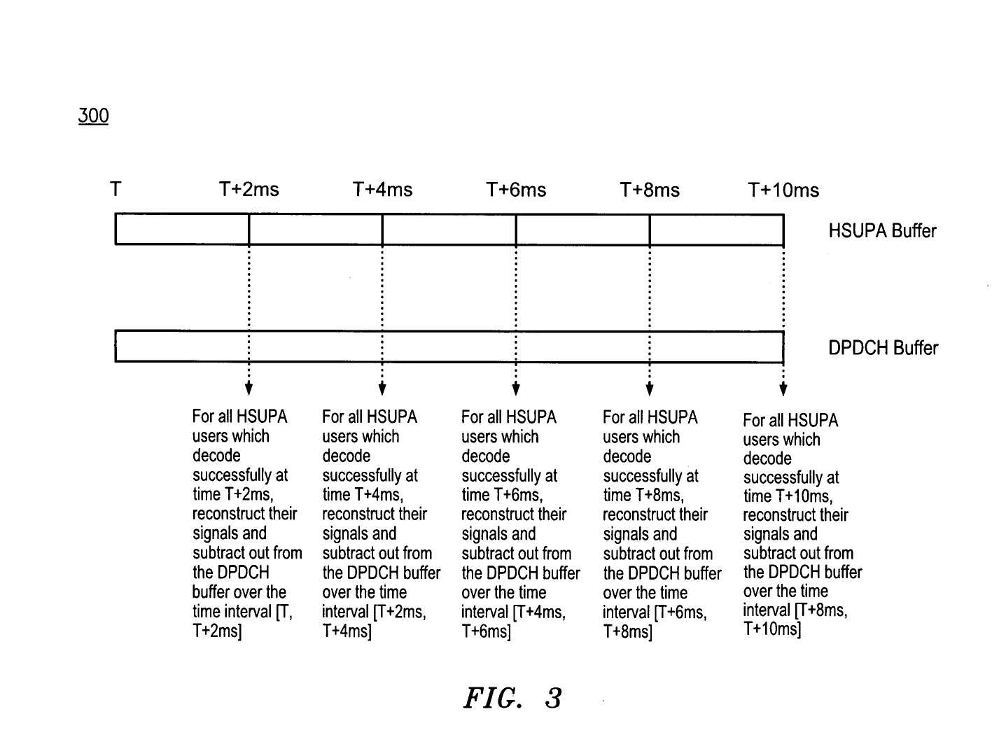

The receiving device then demodulates and decodes (104) at least one second-group user using this interference-canceled signal. Note that this interference-canceled signal is used but may not be the final signal that is actually demodulated and decoded to recover the one or more second-group users. For example, the interference-canceled signal may represent just a portion of the final signal that is actually demodulated and decoded. Diagram 300 in FIG. 3 illustrates one specific example where this occurs. That is, interference signal subtraction occurs signal subtraction occurs during each of the 2 ms intervals to derive the final signal over the 10 ms period.

FIG. 2 is a block diagram depiction of a device for performing interference cancellation in accordance with various embodiments of the present invention. In the device depicted in diagram 200, a first demodulator/decoder 201, a signal re-constructor 202, an interference subtractor 203, and a second demodulator/decoder 204 are shown.

The first demodulator/decoder 201 is for demodulating and decoding at least one first-group user from a multi-user input signal. This multi-user input signal includes at least one first-group user and at least one second-group user, the first-group users having a shorter transmission time interval (TTI) than the second-group users. Coupled to the first demodulator/decoder 201, the signal re-constructor 202 is for reconstructing an interference signal for each of the first-group users that were successfully decoded. Coupled to the signal re-constructor 202, the interference subtractor 203 is for subtracting each of the interference signals from the multi-user input signal to generate an interference-canceled signal. Coupled to the interference subtractor 203, the second demodulator/decoder 204 is for demodulating and decoding at least one second-group user using the interference-canceled signal.

To provide a greater degree of detail in making and using various aspects of the present invention, a description of certain, quite specific, embodiments follows for the sake of example. In one set of embodiments of the present invention (referred to as IC-Lite embodiments), a reduced complexity interference cancellation technique is proposed for HSUPA systems. FIGS. 3-8 are directed to FIGS. 3-8 are directed to various aspects of these IC-Lite embodiments.

In many deployment scenarios, there will be a mix of HSUPA users with legacy CS voice users (i.e., those that utilize the DPDCH). We take advantage of the fact that the DPDCH always has a transmission time interval (TTI) of at least 10 ms, which means that 10 ms worth of data can be buffered before being processed (i.e., demodulated and decoded). HSUPA, on the other hand, can optionally utilize a 2 ms TTI, meaning that the data can be demodulated and decoded after collecting just 2 ms worth of data for each HSUPA user.

The IC-Lite embodiments take advantage of the fact that the DPDCH has a 10 ms TTI length and so there is a 10 ms buffering delay that can be exploited. Since the HSUPA TTI length is only 2 ms, this leaves ample time to decode an HSUPA user, reconstruct the received signal from the HSUPA user who successfully decodes, and subtract out this interference from the buffered data being fed into the DPDCH decoder. In this way, the DPDCH users (e.g., the CS voice users) see a reduced interference level, which improves performance. Note that an HSUPA user may not end up decoding in a particular 2 ms TTI, in which case the interference signal cannot be reconstructed and subtracted out; only HSUPA users which successfully decode in a particular 2 ms TTI are considered for interference cancellation.

The timeline is significantly relaxed compared to the conventional interference cancellation, due to the 10 ms buffering of data for the DPDCH processing. Also, the need for an iterative IC process in which there are multiple stages of decode/reconstruct/subtract are avoided. This significantly reduces the required processing power as well as memory requirements. There are four basic steps involved in the IC-lite technique.
Step 1: Demodulate and decode all HSUPA users in the given 2 ms TTI.
Step 2: For each HSUPA users that decode successfully, reconstruct the received signal that was generated by this user at the front-end of the receiver, i.e., re-encode and re-modulate the signal.
Step 3: Subtract out the reconstructed signals from the HSUPA users that decoded from the 10 ms-delayed buffered signal waiting to be fed into the DPDCH demodulator/decoder.
Step 4: Feed the buffered data, with the interference from HSUPA users who decoded subtracted out, into the DPDCH demodulator/decoder.

A timeline illustrating an example of these steps being performed during a 10 ms interval can be found in diagram 300 of FIG. 3. Generally speaking, steps 1-3 above are repeated during each HSUPA 2 ms transmission time interval and then step 4 is performed in time to process the DPDCH users during the 10 ms DPDCH TTI.

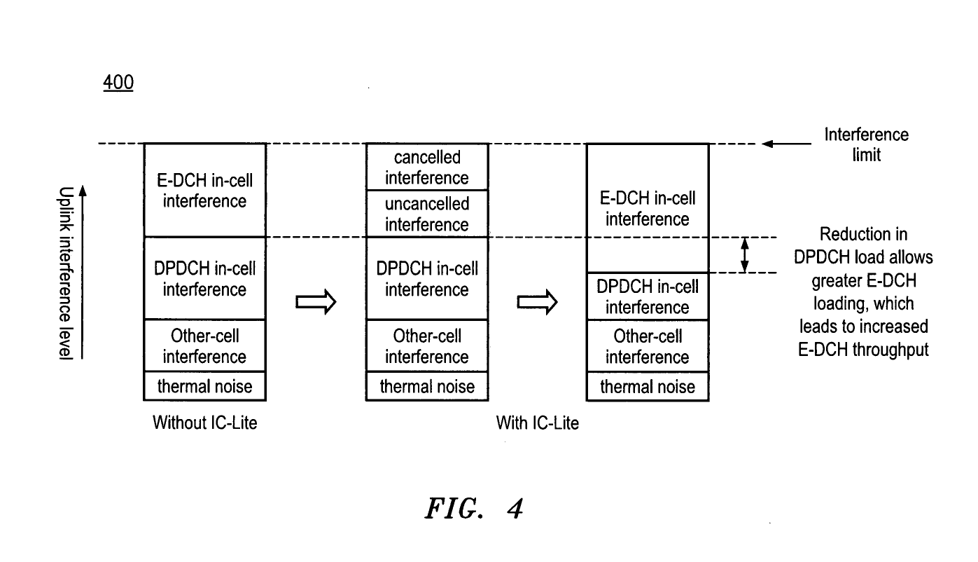

Note that the IC-Lite technique only ends up cancelling HSUPA interference seen by the DPDCH users; that is, HSUPA users themselves do not directly see a reduced interference level. However, because the interference seen by the DPDCH users is reduced, they see an improved signal to interference plus noise ratio (SINR), and because of power control the transmit power levels of the DPDCH users will be reduced, which then ends up reducing the total uplink interference level experienced at the base station receiver. Because the total interference level has been reduced, the base station scheduler can then allocate higher rates to the HSUPA users to move the interference HSUPA users to move the interference level back to the limit it would have been without IC-Lite, and the HSUPA users experience higher throughput. This is illustrated by diagram 400 in FIG. 4.

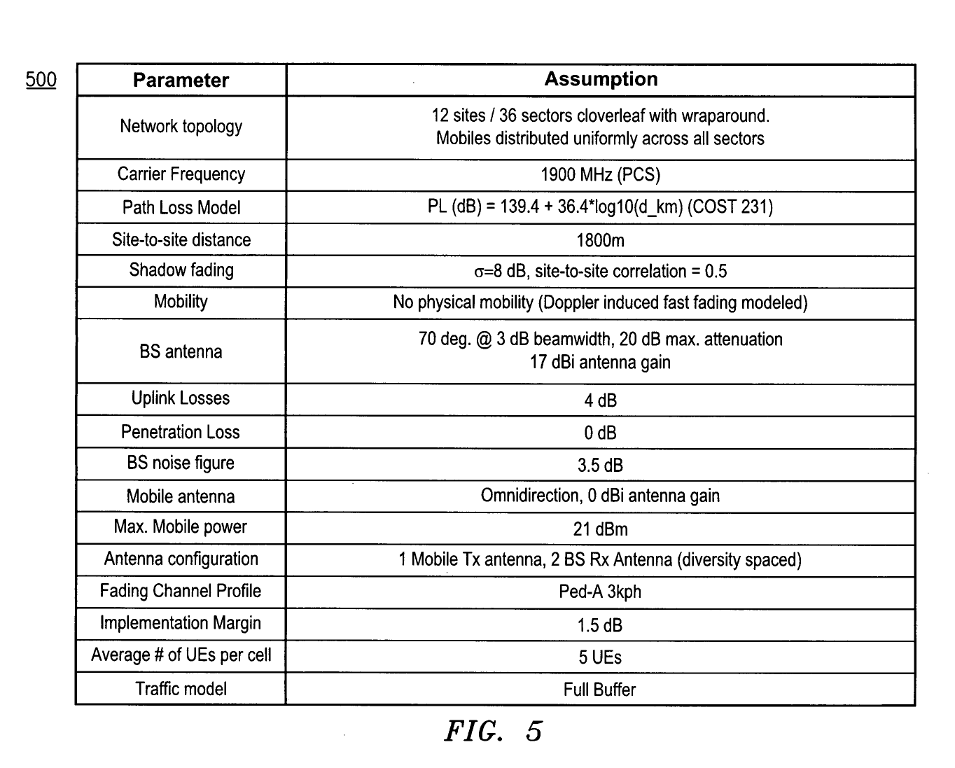

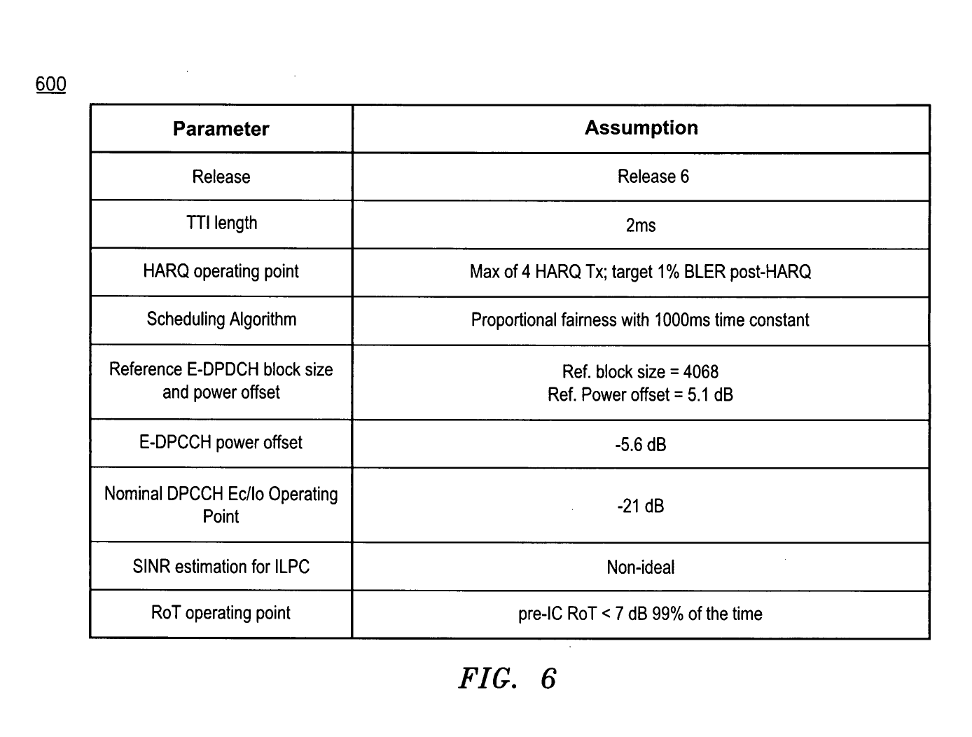

We have studied the performance of IC-Lite under two different deployment conditions in which we simulate a mix of HSUPA users together with CS voice users. The simulation assumptions are shown in tables 500 and 600 in FIGS. 5 and 6, respectively. In this study we assumed a fixed cancellation efficiency of 80%, which is actually on the conservative side based on on-going link level simulation studies. An 80% cancellation efficiency means that when an HSUPA user decodes in a particular TTI, 80% of the interference generated by this user is subtracted out from the DPDCH receiver.

In the first case we consider what is known as an interference limited environment, in which the total uplink received power level divided by the thermal noise level, which is called the rise over thermal (RoT), is constrained to be less than 7 dB more than 99 percent of the time. This is typically an upper limit of the uplink received power level needed to ensure stability of the CDMA system.

In the second deployment condition, we consider a coverage limited environment, where we add a 10 dB penetration loss. In this case, we constrain the mean RoT level to be at most 4 dB, which corresponds to an uplink loading level of load=1−1/RoT=0.6. The reduced RoT level is used in order to maintain the coverage of, e.g., CS voice users, so it is the maximum RoT that can be seen as far as the CS voice users are concerned.

Note that there is no gain from IC-Lite when there are no CS voice users, as expected. Here we see that the gains are at most about 6% where there are CS voice users present. In this case we just need to ensure that the 99^{th} percentile of the RoT is less than 7 dB for both the case of no interference cancellation and with IC-Lite.

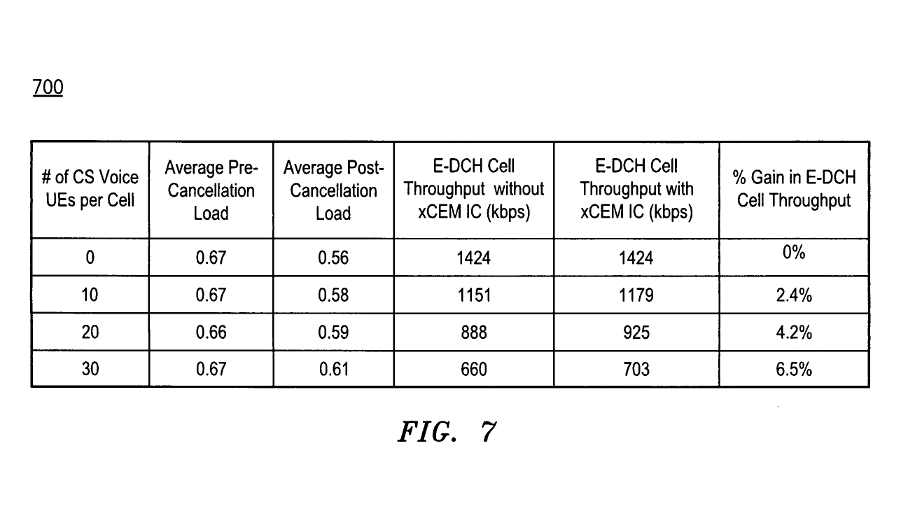

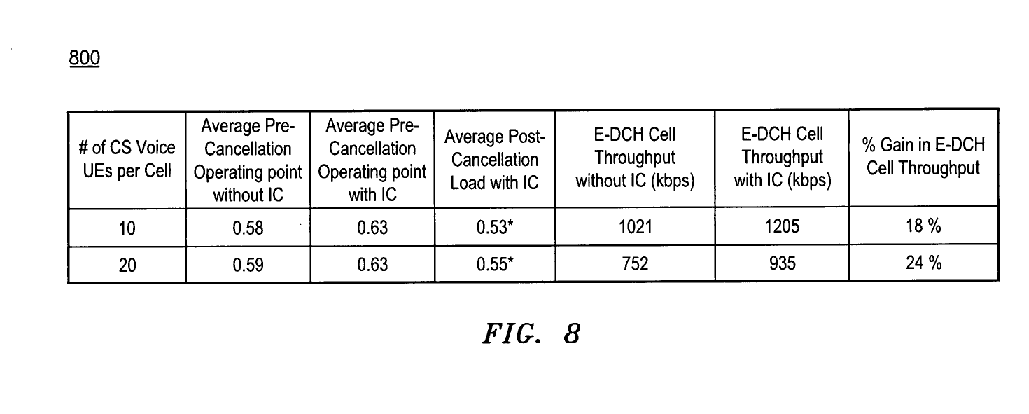

Table 700 in FIG. 7 shows the performance gains offered by IC-Lite in the interference limited deployment scenario, as a function of the number of CS voice users in the cell. Table 800 in FIG. 8 shows the performance gains offered by IC-Lite in coverage limited deployment scenario. Here the load seen by the CS voice users can be no more than 0.6 in order to guarantee coverage for the CS voice users. Without IC-lite, this means that the total uplink loading can be no more than 0.6. However, with IC-Lite, we only need to make sure the load level seen by the CS voice users is no more than 0.6, and with IC-lite the CS voice users only see the fraction of the HSUPA load which is uncancelled. Here we see that up to 25% gain is possible.

The detailed and, at times, very specific description above is provided to effectively enable a person of skill in the art to make, use, and best practice the present invention in view of what is already known in the art. In the examples, the present invention is described in the context of specific architectures, specific system configurations and specific wireless signaling technologies for the purpose of illustrating possible embodiments and a best mode for the present invention. Thus, the examples described should not be interpreted as restricting or limiting the scope of the broader inventive concepts.

Benefits, other advantages, and solutions to problems have been described above with regard to specific embodiments of the present invention. However, the benefits, advantages, solutions to problems, and any element(s) that may cause or result in such benefits, advantages, or solutions, or cause such benefits, advantages, or solutions to become more pronounced are not not to be construed as a critical, required, or essential feature or element of any or all the claims.

As used herein and in the appended claims, the term “comprises,” “comprising,” or any other variation thereof is intended to refer to a non-exclusive inclusion, such that a process, method, article of manufacture, or apparatus that comprises a list of elements does not include only those elements in the list, but may include other elements not expressly listed or inherent to such process, method, article of manufacture, or apparatus. The terms a or an, as used herein, are defined as one or more than one. The term plurality, as used herein, is defined as two or more than two. The term another, as used herein, is defined as at least a second or more. Unless otherwise indicated herein, the use of relational terms, if any, such as first and second, top and bottom, and the like are used solely to distinguish one entity or action from another entity or action without necessarily requiring or implying any actual such relationship or order between such entities or actions.

The terms including and/or having, as used herein, are defined as comprising (i.e., open language). The term coupled, as used herein, is defined as connected, although not necessarily directly, and not necessarily mechanically. Terminology derived from the word “indicating” (e.g., “indicates” and “indication”) is intended to encompass all the various techniques available for communicating or referencing the object/information being indicated. Some, but not all, examples of techniques available for communicating or referencing the object/information being indicated include the conveyance of the object/information being indicated, the conveyance of an identifier of the object/information being indicated, the conveyance of information used to generate the object/information being indicated, the conveyance of some indicated, the conveyance of some part or portion of the object/information being indicated, the conveyance of some derivation of the object/information being indicated, and the conveyance of some symbol representing the object/information being indicated.

What is claimed is:

1. A method for performing interference cancellation comprising:
demodulating and decoding at least one first-group user from a multi-user input signal, wherein the multi-user input signal comprises at least one first-group user and at least one second-group user and wherein first-group users have a shorter transmission time interval (TTI) than second-group users;
reconstructing an interference signal for each of the at least one first-group users that were successfully decoded;
subtracting the interference signal for each of the at least one first-group users from the multi-user input signal to generate an interference-canceled signal;
demodulating and decoding at least one second-group user using the interference-canceled signal.

2. The method as recited in claim 1, wherein demodulating and decoding at least one first-group user from the multi-user input signal comprises
attempting to demodulate and decode all first-group users encoded in the multi-user input signal.

3. The method as recited in claim 2, wherein reconstructing an interference signal for each of the at least one first-group users that were successfully decoded comprises
reconstructing an interference signal for each of the first-group users that were successfully decoded in attempting to demodulate and decode all first-group users encoded in the multi-user input signal.

4. The method as recited in claim 1, wherein demodulating and decoding at least one first-group user from the multi-user input signal comprises
concurrently demodulating and decoding multiple first-group users from the multi-user input signal.

5. The method as recited in claim 1, wherein reconstructing an interference signal for each of the at least one first-group users that were successfully decoded comprises
re-encoding and re-modulating an interference signal for each of the at least one first-group users that were successfully decoded.

6. The method as recited in claim 1, wherein the at least one first-group user comprises a packet data user and the at least one second-group user comprises a voice user.

7. The method as recited in claim 1, wherein first-group users have a 2 millisecond TTI and second-group users have a 10 millisecond TTI.

8. A receiver comprising:
a first demodulator/decoder for demodulating and decoding at least one first-group user from a multi-user input signal, wherein the multi-user input signal comprises at least one first-group user and at least one second-group user and wherein first-group users have a shorter transmission time interval (TTI) than second-group users;
a signal re-constructor for reconstructing an interference signal for each of the at least one first-group users that were successfully decoded;
an interference subtractor for subtracting the interference signal for each of the at least one first-group users from the multi-user input signal to generate an interference-canceled signal; and
a second demodulator/decoder for demodulating and decoding at least one second-group user using the interference-canceled signal.

9. The receiver as recited in claim 8, wherein the first demodulator/decoder is adapted to
attempt to demodulate and decode all first-group users encoded in the multi-user input signal.

10. The receiver as recited in claim 9, wherein the signal re-constructor is adapted to
reconstruct an interference signal for each of the first-group users that were successfully decoded in attempting to demodulate and decode all first-group users encoded in the multi-user input signal.

11. The receiver as recited in claim 8, wherein the first demodulator/decoder is adapted to
concurrently demodulate and decode multiple first-group users from the multi-user input signal.

12. The receiver as recited in claim 8, wherein the signal re-constructor is adapted to
re-encode and re-modulate an interference signal for each of the at least one first-group users that were successfully decoded.
